(19) United States
(12) Patent Application Publication
(10) Pub. No.: US 2026/0312911 A1
(43) Pub. Date: Oct. 8, 2026

(54) ON-DEVICE ECN MARKING API

(71) Applicant: QUALCOMM Incorporated, San Diego, CA (US)

(72) Inventors: Saadallah KASSIR, San Diego, CA (US); Ravi AGARWAL, San Diego, CA (US); Prashanth Haridas HANDE, San Diego, CA (US); Peerapol TINNAKORNSRISUPHAP, San Diego, CA (US); Hyun Yong LEE, San Diego, CA (US)

(21) Appl. No.: 19/173,654

(22) Filed: Apr. 8, 2025

(51) Int. Cl. H04L 47/26; H04L 47/30

(52) U.S. Cl. CPC H04L 47/26; H04L 47/30

(57) ABSTRACT

This disclosure provides wireless devices, methods, and apparatuses for congestion control. The apparatus receives, at a modem or an operating system, via an application programming interface (API) accessible by an application, a subscription of the application to an explicit congestion notification (ECN) marking report service for an IP flow. The apparatus provides, to the application via the API, a congestion report based on IP packets of the IP flow marked with an ECN field received at the modem. The modem or the operating system may receive via the API, an indication of an ECN codepoint to be applied to an IP flow; identify one or more packets corresponding to the IP flow at a packet data convergence protocol (PDCP) layer; and add the ECN codepoint to an IP header of the one or more packets at the PDCP layer prior to transmission via a wireless protocol.

### TECHNICAL FIELD

The present disclosure relates to an on-device explicit congestion notification (ECN) marking application programming interface (API). For example, the ECN on-device marking API may be implemented in an extended reality device.

### DESCRIPTION OF THE RELATED TECHNOLOGY

Extended reality utilizes a display, usually as part of a headset, to display objects in relation to a field of view of a user. Conventional XR devices have utilized local processing and storage of object resources to generate visual representations of the objects on the display. Access to remote resources for XR may improve user experience by shifting the storage location of resources and expanding the range of available objects to provide more dynamic XR experiences while making XR applications more lightweight.

The use of remote resources for XR, however, raises an issue of communications latency. In order to provide high levels of quality of service (QoS) or quality of experience (QoE) for XR devices, communications must be low latency, high reliability, high bandwidth, and low power consumption.

To minimize end-to-end (E2E) delay, video rate adaptation mechanisms have been proposed to adjust the video encoding bitrate to network congestion. Two types of congestion control mechanisms include over the top (OTT) algorithms and network assisted algorithms. In OTT algorithms, a rate adaptation client provides congestion information/measurements (e.g., round trip time (RTT)) as feedback to the server (e.g., using real-time control protocol (RTCP)) that can in turn adjust the encoding rate accordingly. In network-assisted algorithms, the network provides a congestion indication whenever congestion is experienced. For example, a switch relaying IP packets may use the ECN field in the Internet protocol (IP) packet header. The rate adaptation client uses this information to detect congestion and inform the server.

L4S (Low Latency, Low Loss, and Scalable Throughput) is one example of a network-assisted congestion control framework that leverages the ECN field in the IP header to provide congestion information to the application-layer congestion control algorithm. In some devices, however, IP packets may be altered before reaching the application-layer congestion control algorithm.

### SUMMARY

The systems, methods and devices of this disclosure each have several innovative aspects, no single one of which is solely responsible for the desirable attributes disclosed herein.

In some aspects, the techniques described herein relate to an apparatus for wireless communication, including: one or more memories storing computer-executable instructions; and one or more processors configured to execute the computer-executable instructions to cause the apparatus to: receive, at a modem or an operating system of the apparatus, via an application programming interface (API) accessible by an application, a subscription of the application to an explicit congestion notification (ECN) marking report service for an internet protocol (IP) flow; and provide, to the application via the API, a congestion report based on IP packets of the IP flow marked with an ECN field received at the modem or based on IP packets of the IP flow transmitted from the modem.

In some aspects, the techniques described herein relate to a method of communication, including: receiving, at a modem or an operating system of a wireless device, via an application programming interface (API) accessible by an application, a subscription of the application to an explicit congestion notification (ECN) marking report service for an internet protocol (IP) flow; and providing, to the application via the API, a congestion report based on IP packets of the IP flow marked with an ECN field received at a packet data convergence protocol (PDCP) layer of the modem or based on IP packets of the IP flow transmitted from the modem.

In some aspects, the techniques described herein relate to a method of communication, including: receiving, at a modem or an operating system of a wireless device, via an application programming interface (API) accessible by an application, an indication of an explicit congestion notification (ECN) codepoint to be applied to an IP flow; identifying one or more packets corresponding to the IP flow at a packet data convergence protocol (PDCP) layer; and adding the ECN codepoint to an IP header of the one or more packets at the PDCP layer prior to transmission via a wireless protocol.

In some aspects, the techniques described herein relate to an apparatus including: means for receiving, at a modem or an operating system of a wireless device, via an application programming interface (API) accessible by an application, a subscription of the application to an explicit congestion notification (ECN) marking report service for an internet protocol (IP) flow; and means for providing, to the application via the API, a congestion report based on IP packets of the IP flow marked with an ECN field received at a packet data convergence protocol (PDCP) layer of the modem or based on IP packets of the IP flow transmitted from the modem.

In some aspects, the techniques described herein relate to a non-transitory computer-readable medium storing computer-executable instructions that when executed by a processor of a wireless device cause the processor to: receive, at a modem or an operating system of the wireless device, via an application programming interface (API) accessible by an application, a subscription of the application to an explicit congestion notification (ECN) marking report service for an internet protocol (IP) flow; and provide, to the application via the API, a congestion report based on IP packets of the IP flow marked with an ECN field received at the modem or based on IP packets of the IP flow transmitted from the modem.

In some aspects, the techniques described herein relate to an apparatus including: means for receiving, at a modem or an operating system of a wireless device, via an application programming interface (API) accessible by an application, an indication of an explicit congestion notification (ECN) codepoint to be applied to an IP flow; means for identifying one or more packets corresponding to the IP flow at a packet data convergence protocol (PDCP) layer; and means for adding the ECN codepoint to an IP header of the one or more packets at the PDCP layer prior to transmission via a wireless protocol.

In some aspects, the techniques described herein relate to a non-transitory computer-readable medium storing computer-executable instructions that when executed by a processor of an extended reality device cause the processor to: receive, at a modem or an operating system of a wireless device, via an application programming interface (API) accessible by an application, an indication of an explicit congestion notification (ECN) codepoint to be applied to an IP flow; identify one or more packets corresponding to the IP flow at a packet data convergence protocol (PDCP) layer; and add the ECN codepoint to an IP header of the one or more packets at the PDCP layer prior to transmission via a wireless protocol.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of an environment of an extended reality (XR) device.

FIG. 2 is a diagram illustrating an example of congestion control for a communications link.

FIG. 3 is a diagram illustrating an example of downlink congestion control for a communications link using a northbound explicit congestion notification (ECN) application programming interface (API) between a modem and an application layer congestion controller.

FIG. 4 is a diagram illustrating an example of uplink congestion control for a communications link using a southbound ECN API between an application layer congestion controller and a modem.

FIG. 5 is a flowchart of an example method of downlink congestion control.

FIG. 6 is a flowchart of an example method of uplink congestion control.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways.

In some implementations, the accelerator architectures described herein may implement wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, 6G or further implementations thereof, technology. However, the apparatuses and techniques described herein may be implemented in any device, system or network regardless of compliance any particular standard specification.

Extended reality (XR) utilizing remote resources may utilize either a pixel-streaming architecture or an object-streaming architecture. In a pixel-streaming architecture, rendering may be performed on a remote server and video is streamed to the XR device. Pixel streaming allows for high quality rendering, but is expensive to deploy, bandwidth intensive, and latency sensitive at a video frame level. In an object-streaming architecture, rendering may be performed locally based on 3D objects being fetched from a stateless hyper-text transfer protocol (HTTP) webserver. The XR device may only fetch objects that are relevant to a given field of view (FoV). The XR device can decide on the level of detail (LoD) to be downloaded. A high LoD provides better graphics quality but larger file sizes that take longer to download. An object-streaming architecture is cheaper to deploy and more scalable, but relies on device hardware for rendering and is latency sensitive at the object level.

In either pixel-streaming or object-streaming, an application may need to manage data rates based on network congestion. Although various congestion control mechanisms are known in the art, a congestion controller at an application layer (e.g., within an XR application) may not have access to congestion information carried in internet protocol (IP) packet headers. Similar scenarios can occur in non-XR devices where an application has the ability to manage data rates based on requested content.

In an aspect, the present disclosure provides an on-device application programming interface (API) between a wireless modem and an application. The API provides information from lower layers of a communications protocol stack to the application layer. The API may bypass intermediate layers that can erase or alter congestion information. The API may also receive information from the application and ensure correct marking of packets upon transmission. Further, because the wireless modem has some information about network congestion, the wireless modem may provide congestion feedback to the application that is not dependent on a network round trip time and is not affected by potential erasures or alterations within the network.

The API may allow the application to obtain information regarding congestion that is not available or not correct due to the intermediate layers. Accordingly, the application may provide a better user experience, for example, by selecting a bit rate that is less likely to experience congestion. Additionally, the application may adapt to congestion, particularly uplink congestion, faster because the API can eliminate the round trip time in measuring uplink congestion. In some implementations, the API may allow the application to provide more accurate congestion information to a network node by marking packets as indicated by the application rather than the intermediate layers.

Several aspects of an on-device API will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

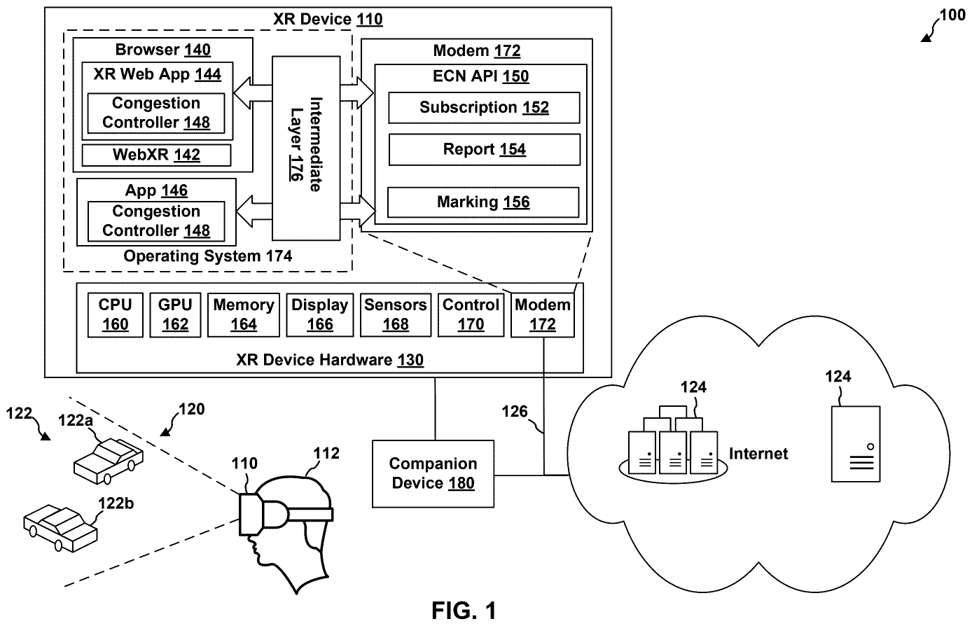

FIG. 1 is a diagram illustrating an example of an environment 100 of an example extended reality (XR) device 110. The XR device 110 may be, for example, an augmented reality (AR) device, a virtual reality (VR) device, or a mixed reality (MR) device. The XR device 110 may be an XR headset worn on a head of a user 112. The XR device 110 may render objects 122 relative to a field of view (FoV) 120 of the user 112. For example, the objects 122 may include a first object 122a and a second object 122b. As the user 112 changes head position, the FoV 120 may change and an object 122 may move out of a field of view and a new object may move into the FoV 120. The objects 122 may be stored on a remote server 124. For example, the remote server 124 may be a server in a datacenter or an individual server. The XR device 110 may communicate with the remote server 124 via a network connection 126. For instance, communications may utilize HTTP request and response message. In some implementations, the network connection 126 may include a wireless connection.

In some implementations, the XR device 110 may be connected to one or more companion devices 180. For instance, the companion device 180 may be a user equipment (UE), mobile station (STA), access point (AP), gaming console, etc. The network connection 126 may include the companion device 180. For example, the XR device 110 may communicate with the companion device 180 via a first wired or wireless connection, then the companion device 180 may forward communications to or from the remote server 124.

The XR device 110 includes XR device hardware 130. The XR device hardware 130 can include a display 166, a graphics processing unit (GPU) 162, a central processing unit (CPU) 160, memory 164 (e.g., random access memory (RAM)) and storage (e.g., solid state). The XR device hardware 130 can include positioning sensors 168 such as inertial measurement units (IMUs) and eye tracking sensors. The XR device hardware 130 can include communications components such as a modem 172 or network interface. In some implementations, the XR device hardware 130 includes a hand control 170, which may include a hand-held or hand-worn controller, which may include its own positioning sensors and/or buttons. Although aspects of the present disclosure are discussed with reference to an XR device, the principles discussed herein may also be applicable to other wireless devices, which may not be in the form of a headset or include components such as hand control 170.

In some implementations, the XR device 110 includes a browser 140 that executes on a processor (e.g., the CPU 160) of the XR device 110. The browser 140 may include a WebXR API 142 that communicates with the XR device hardware 130. An XR web application 144 includes software that executes within the browser 140. The XR web application 144 may provide an XR experience, for example, by selecting objects 122 to render and controlling interactions between the user 112 and the objects 122. For instance, an object 122 may respond to an action of the user indicated via a hand device. In other implementations, an application 146 may execute within the operating system 174 of the XR device 110 without use of the WebXR API 142. In either case, the XR web application 144 or the application 146 may operate on a pixel streaming architecture instead of an object streaming architecture. Further, the XR web application 144 and/or the application 146 may include a congestion controller 148 for managing congestion, for example, according to L4S protocols.

The modem 172 may implement a wireless protocol for communicating data such as streaming video or objects from the server 124. In some implementations, the wireless protocol may be a cellular protocol such as the 3GPP 5G standards or a local area network standard such as the IEEE 802.11 wireless standards. The modem 172 may operate at a network layer, data link layer, and physical layer of the open systems interconnection (OSI) model. The congestion controller 148 may operate at the application layer of the OSI model.

An intermediate layer 176 may exist on a communications path between the modem 172 and the XR web application 144 and/or the application 146. As one example, the intermediate layer may be a middleware service such as WebRTC. WebRTC is an open standard that allows web applications to use video, voice, and data between peers. WebRTC may provide content of IP packets to an application, but may erase or modify IP header information such as ECN markings. As other examples, the WebXR API 142, browser 140, or operating system 174 may act as an intermediate layer. A congestion controller 148 within an application may not be able to access or rely on ECN markings, for example, for L4S protocols.

In an aspect, the present disclosure provides an ECN API 150 that can communicate ECN marking information between the modem 172 and an application such as the XR Web app 144 or the application 146. The ECN API 150 may operate in one or both of a northbound direction from the modem to the application or in a southbound direction from the application to the modem. The ECN API 150 may include a subscription component 152, a report component 154, and a marking component 156. The subscription component 152 is configured to receive a subscription to an ECN marking report service for an IP flow. The report component 154 is configured to provide a congestion report based on IP packets marked with an ECN field received at a packet data convergence protocol (PDCP) layer of the modem 172. The marking component 156 is configured to receive, from an application, an indication of an ECN marking to be applied to an IP flow, identifying one or more packets corresponding to the IP flow at a PDCP layer, and adding the ECN marking to an IP header of the one or more packets at the PDCP layer prior to transmission via a wireless protocol.

Although the ECN API 150 is illustrated as implemented by the modem 172, in some implementations, the ECN API 150 may be implemented by the operating system 174. For instance, some of the actions of the ECN API 150 are described as occurring at the PDCP layer in the modem 172. Alternatively, when the ECN API 150 is implemented in the operating system 174, the actions may occur at a transport layer above the PDCP layer. The transport layer may provide protocol data unit (PDU) packets to the PDCP layer as a PDCP service data unit (SDU).

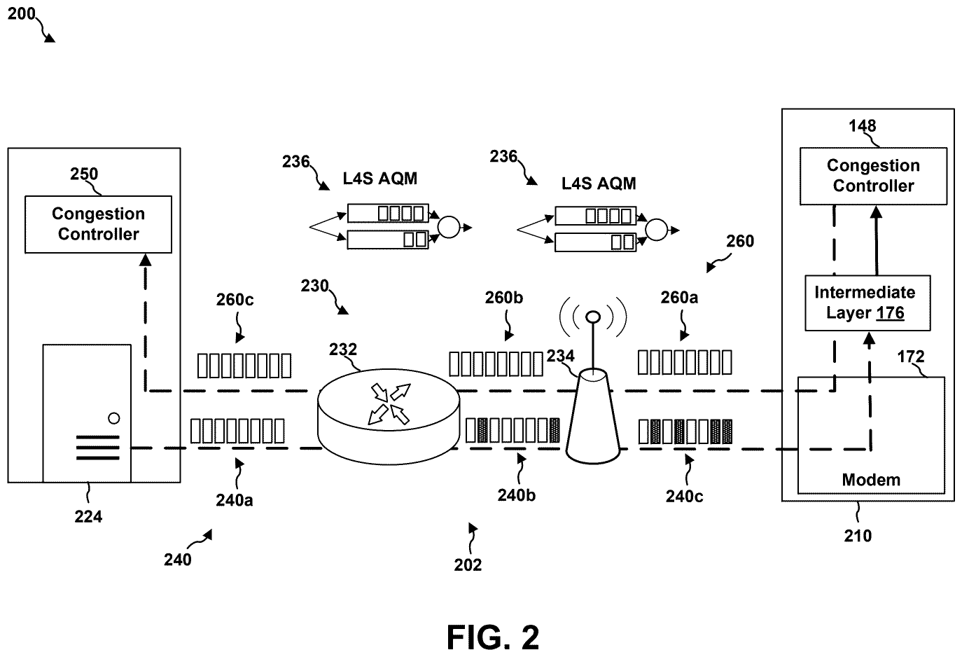

FIG. 2 is a diagram 200 illustrating an example of congestion control for a communications link 202. The communications link 202 may connect a device 210 (e.g., the XR device 110) with a server 224 (e.g., the server 124). In an example, the congestion control may follow the L4S framework defined in RFC 9330.

The communication link 202 may traverse network nodes 230 such as a router 232 and a gNB 234. Each network node 230 may include an L4S active queue management (AQM) module 236 that provides a separate queue of L4S traffic. In the downlink direction, the server 224 may send a plurality of packets 240. For example, the packets may be IP packets within a flow (i.e., defined by an IP 5-tuple of source address, source port, destination address, destination port, and protocol).

An L4S-capable node may set the ECN field to CE as an early congestion indicator (as compared to packet drop), as a function of its queue state. Initially, the packets 240 may include an explicit congestion notification (ECN) field that is marked in the IP header as L4S traffic but not congested (i.e., not a value of 11 indicating congestion). As the packets 240 traverse network nodes such as the router 232 or the gNB 234, each network node may mark one or more packets 240 if congestion was experienced. ECN marking policy is vendor-specific, but marking probability is expected to be a function of the L4S and Classic queue sizes of the AQN module 236 and queueing delays and possibly channel quality. For instance, the packets 240a sent by the server 224 may have no packets marked, the packets 240b forwarded by the router 232 may have a few packets marked, and the packets 240c transmitted by the gNB may have more packets marked.

The packets 240 may be received at the modem 172 of the device 210. The ECN field is read at the Rx side, and congestion is reported back to the server 124. The modem 172 and/or the congestion controller 148 may determine congestion levels based on the number of marked packets. The modem 172 may provide the marked packets and/or congestion information to a congestion controller 148. In the uplink, the congestion controller 148 may provide feedback regarding the level of congestion to a congestion controller 250 at the server 224. For example, the congestion controller 148 may include ECN markings in the TCP ACK header or via RTCP when RTP is used on top of UDP. ECN marks get detected by the client congestion controller 148 1-RTT after marking.

In a scenario where the intermediate layer 176 affects ECN markings, congestion information may not be available, or may not be accurate. For example, the intermediate layer 176 may provide the content of the packets 240c, but not the IP headers, so the congestion controller 148 may not be aware of downlink congestion. Similarly, on the uplink, the feedback information may be erased or altered by the intermediate layer 176. For instance, uplink packets 260a may include no ECN markings, giving the false impression that no congestion was experienced. Or only congestion at the gNB 234 indicated in packets 260b and congestion at the router 232 indicated in packets 260c may be accurate.

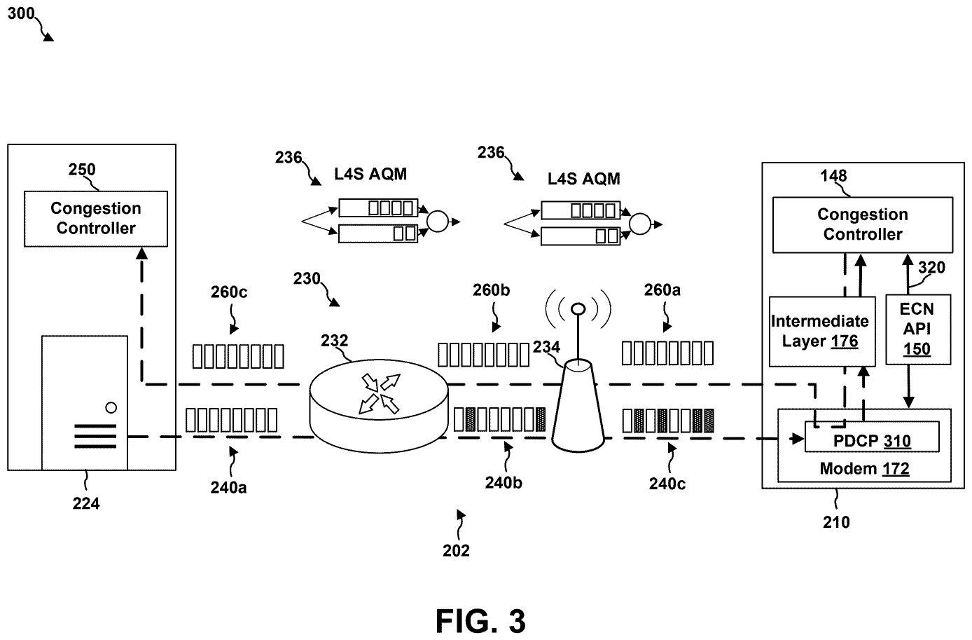

FIG. 3 is a diagram 300 illustrating an example of downlink congestion control for a communications link 202 using a northbound ECN API 150 between a modem 172 and an application layer congestion controller 148. The ECN API 150 may be implemented on the modem 172 and communicate with the congestion controller 148.

The modem 172 includes a packet data convergence protocol (PDCP) layer 310 that communicates packets such as IP packets with higher layers. The PDCP layer 310 may assemble downlink packets 240 from lower layer units and pass the IP packets to the intermediate layer 176. As noted above, the intermediate layer 176 may erase or modify ECN markings on packets. The PDCP layer 310 may also extract ECN packet markings before packets are passed to the intermediate layer. The ECN API 150 may provide ECN marking information to the congestion controller, bypassing the intermediate layer 176. For instance, the congestion controller 148 may subscribe to an ECN marking report 320 for an IP flow identified by a 5-tuple={source IP, destination IP, source port, destination port, protocol}. In some implementations, the subscription may include a requested periodicity.

In some implementations, the API 150 may provide an ECN marking report 320 periodically as a number of received IP packets and a number of marked IP packets. Generally, since ECN marking is probabilistic, the numbers of packets are more important than the which packets were marked. The number or ratio of marked packets may alternatively be expressed as a percentage of marked IP packets.

In some implementations, the API 150 may provide an ECN marking report 320 for a predetermined number of received IP packets. For instance, the API 150 may indicate a number or percentage of marked IP packets to the congestion controller 148 when the modem 172 has received the predetermined number, then reset a counter.

In another implementation, the congestion controller 148 may request data from the API 150. For instance, upon request, the API 150 may provide the number of received IP packets and the number of marked IP packets since the last request. Once again, the number may alternatively be represented as a percentage.

In some implementations, the API 150 may provide other information related to ECN marking information. For example, the modem 172 may receive recommended bit rate (RBR) signals from a network node such as the gNB 234. The API 150 may forward the received RBR signals to the congestion controller 148, for example, as part of the report 320. In some implementations, the RBR may be normalized to a value between 0 and 1. As another example, the modem 172 may provide uplink buffer state or queueing delay information to the congestion controller via the API 150, for example, as part of the report 320. In some implementations, the uplink buffer state or queueing delay information may be normalized to a value between 0 and 1 to remain compatible with L4S rate control algorithms. The congestion controller 148 may indicate whether to receive the other information in the subscription to ECN marking information.

In an implementation, the API 150 may also provide uplink ECN marking information to the congestion controller 148. For example, the modem 172 may mark packets with ECN markings based on transmission delays. For instance, the ECN marking may be based on an uplink buffer size or time spent in the uplink buffer waiting for transmission resources. Under L4S protocols, the uplink packets 260a may be marked by the modem. The congestion controller 250 may then provide feedback to the modem 172 in subsequent downlink packets 240a. Because the delay in an uplink wireless connection is expected to be on the wireless link between the modem 172 and the gNB 234, the ECN marking information may be useful to a congestion controller 148 (e.g., to determine uplink data rate). In some implementations, the API 150 may provide ECN marking information of uplink packets 260 to the congestion controller 148. Once again, marking information may be expressed as a number or percentage of packets. The marking information provided via the API 150 may be faster than feedback received from the congestion controller 250. Additionally, the marking information provided via the API 150 is not subject to erasure or alteration at intermediate network nodes. In some implementations, the uplink ECN marking information may be hypothetical because the modem 172 may not actually mark the packets because the congestion controller 148 receives the congestion information via the API 150.

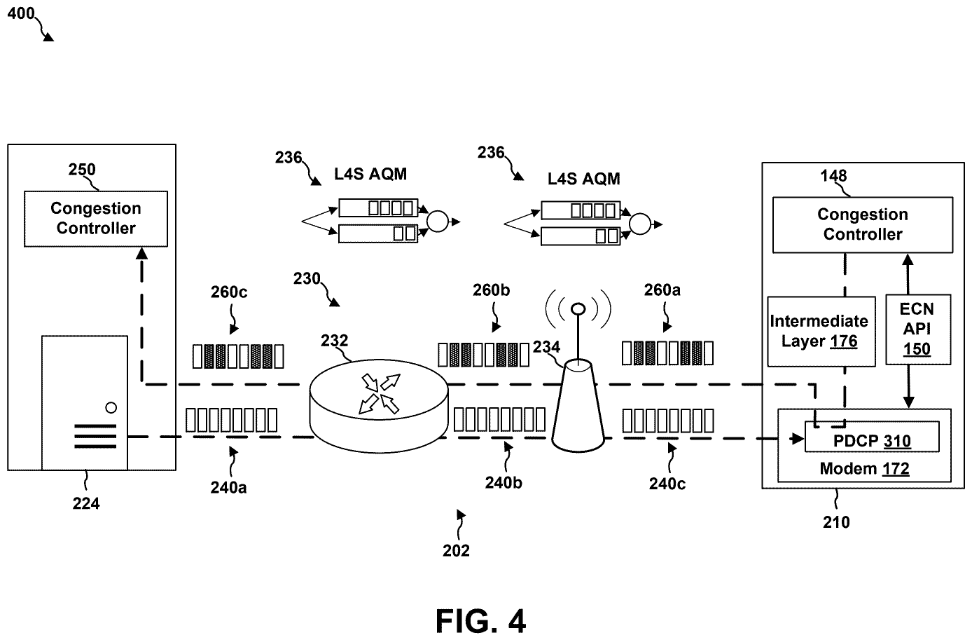

FIG. 4 is a diagram 400 illustrating an example of uplink congestion control for a communications link 202 using a southbound ECN API 150 between an application layer congestion controller and a modem. The ECN API 150 may be implemented on the modem 172 or in the operating system 174. The ECN API 150 may communicate with the congestion controller 148 in either the XR web application 144 or the application 146.

As noted above, the intermediate layer 176 may erase or modify ECN markings on uplink packets. For example, if the congestion controller 148 marks uplink packets 260 with ECN markings, the intermediate layer 176 may erase or alter the ECN markings.

In an aspect, the API 150 may communicate uplink ECN marking information to the modem 172. For example, the API 150 may allow the congestion controller 148 to indicate an IP flow identified by a 5-tuple to be marked with a codepoint. The API 150 may provide a confirmation or error indication of whether the IP flow has been configured. The PDCP layer 310 of the modem 172 may apply the ECN markings to IP packets that have already traversed the intermediate layer 176. In some implementations, the PDCP layer 310 may apply ECN markings probabilistically based on a rate indicated by the API 150. For instance, the modem 172 sets the IP packet (PDCP SDU) header based on the indicated codepoint. Accordingly, the uplink packets 260a transmitted by the modem 172 can carry the correct ECN markings.

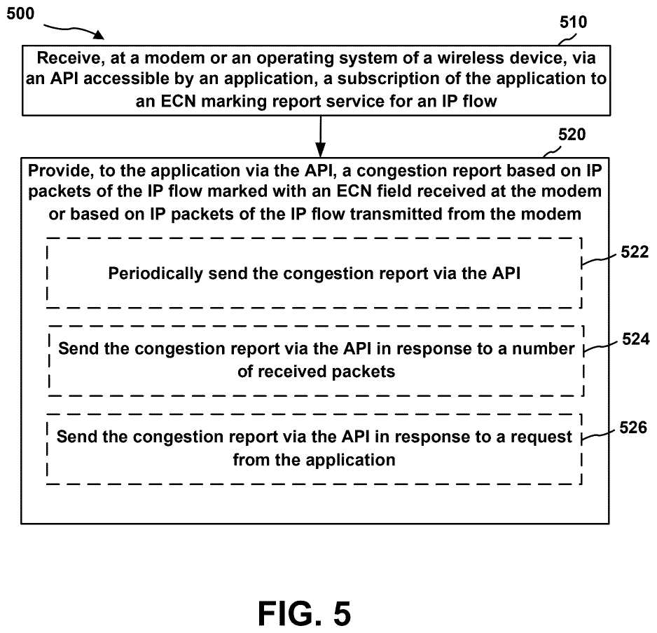

FIG. 5 is a flowchart of an example method 500 of downlink congestion control. The method 500 may be performed by a wireless device such as the XR device 110 or one or more components thereof including the XR device hardware 130. The method 500 may be performed in communication with a web server 124. Optional blocks are shown with dashed lines.

At block 510, the method 500 includes receiving, at a modem or an operating system of a wireless device, via an API accessible by an application, a subscription of the application to an ECN marking report service for an IP flow. In some implementations, for example, the modem 172 or the operating system 174 executing on the CPU 160 may receive, via an API accessible by an application 146, a subscription of the application to an ECN marking report service for an IP flow. Accordingly, the modem 172 or the operating system 174 executing on the CPU 160 may provide means for receiving, at a modem or an operating system of a wireless device, via an API accessible by an application, a subscription of the application to an ECN marking report service for an IP flow.

At block 520, the method 500 includes providing, to the application via the API, a congestion report based on IP packets of the IP flow marked with an ECN field received at a PDCP layer of the modem or based on IP packets of the IP flow transmitted from the modem. In some implementations, for example, the modem 172 or the operating system 174 executing on the CPU 160 may provide, to the application via the API 150, a congestion report 320 based on IP packets (e.g., packets 240c) of the IP flow marked with an ECN field received at a PDCP layer 310 of the modem or based on IP packets (e. g, packets 260a) of the IP flow transmitted from the modem. In implementations where the operating system 174 includes the API 150, the PDCP layer 310 of the modem may provide the IP packets to the operating system 174 (e.g., at a transport layer).

In some implementations, at sub-block 522, the block 520 may optionally include periodically sending the congestion report via the API. In some implementations, at sub-block 524, the block 520 may optionally sending the congestion report via the API in response to a number of received packets. In some implementations, at sub-block 526, the block 520 may optionally include sending the congestion report via the API in response to a request from the application.

In some implementations, the congestion report includes ECN marking information. In some implementations, the congestion report includes a recommended bit rate received from a network node for the IP flow. In some implementations, the congestion report includes an uplink buffer state or queueing delay of the IP packets of the IP flow transmitted from the modem.

In view of the foregoing, the modem 172 or the operating system 174 executing on the CPU 160 may provide means for providing, to the application via the API, a congestion report based on IP packets of the IP flow marked with an ECN field received at a PDCP layer of the modem or based on IP packets of an IP flow transmitted from the modem.

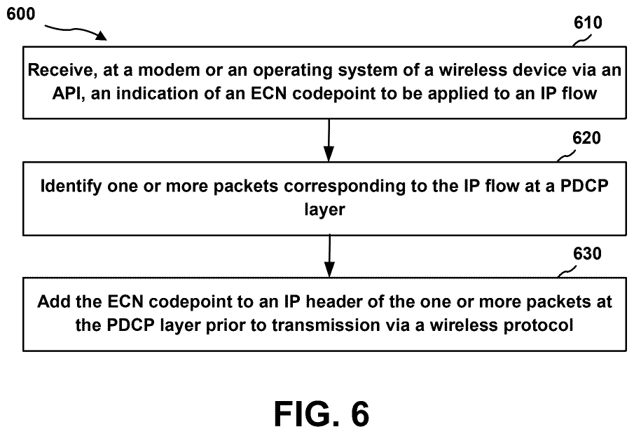

FIG. 6 is a flowchart of an example method 600 of uplink congestion control. The method 600 may be performed by a wireless device such as the XR device 110 or one or more components thereof including the XR device hardware 130. The method 600 may be performed in communication with a web server 124. In some implementations, the method 600 may optionally be performed before, concurrently with, or after the method 500. Optional blocks are shown with dashed lines.

At block 610, the method 600 includes receiving, at a modem or an operating system of a wireless device, via an API accessible by an application, an indication of an ECN codepoint to be applied to an IP flow. In some implementations, for example, the modem 172 or the operating system 174 executing on the CPU 160 may receive via an API 150 accessible by an application, an indication of an ECN codepoint to be applied to an IP flow (e.g., packets 260). Accordingly, the modem 172 or the operating system 174 executing on the CPU 160 may provide means for receiving, at a modem or an operating system of a wireless device, via an API accessible by an application, an indication of an ECN codepoint to be applied to an IP flow.

At block 620, the method 600 includes identifying one or more packets corresponding to the IP flow at a PDCP layer. In some implementations, for example, the modem 172 or the operating system 174 executing on the CPU 160 may identify one or more packets corresponding to the IP flow at a PDCP layer 310. For example, the modem 172 may identify the packets 260 when receiving the PDCP SDU from the operating system, or the operating system 174 may identify the packets 260 when sending the PDCP SDU (transport layer PDU) to the modem 172. Accordingly, the modem 172 or the operating system 174 executing on the CPU 160 may provide means for identifying one or more packets corresponding to the IP flow at a PDCP layer.

At block 630, the method 600 includes adding the ECN codepoint to an IP header of the one or more packets at the PDCP layer prior to transmission via a wireless protocol. In some implementations, for example, the modem 172 or the operating system 174 executing on the CPU 160 may add the ECN codepoint to an IP header of the one or more packets at the PDCP layer prior to transmission via a wireless protocol. Accordingly, the modem 172 or the operating system 174 executing on the CPU 160 may provide means for adding the ECN codepoint to an IP header of the one or more packets at the PDCP layer prior to transmission via a wireless protocol.

The following numbered clauses provide an overview of aspects of the present disclosure:

Clause 1. An apparatus for wireless communication, comprising: one or more memories storing computer-executable instructions; and one or more processors configured to execute the computer-executable instructions to cause the apparatus to: receive, at a modem or an operating system of the apparatus, via an application programming interface (API) accessible by an application, a subscription of the application to an explicit congestion notification (ECN) marking report service for an internet protocol (IP) flow; and provide, to the application via the API, a congestion report based on IP packets of the IP flow marked with an ECN field received at the modem or based on IP packets of the IP flow transmitted from the modem.

Clause 2. The apparatus of clause 1, wherein to provide the congestion report, the one or more processors are configured to execute the computer-executable instructions to cause the apparatus to periodically send the congestion report via the API.

Clause 3. The apparatus of clause 1, wherein to provide the congestion report, the one or more processors are configured to execute the computer-executable instructions to cause the apparatus to send the congestion report via the API in response to a number of received packets.

Clause 4. The apparatus of clause 1, wherein to provide the congestion report, the one or more processors are configured to execute the computer-executable instructions to cause the apparatus to send the congestion report via the API in response to a request from the application.

Clause 5. The apparatus of any of clauses 1-4, wherein the report includes ECN marking information.

Clause 6. The apparatus of any of clauses 1-5, wherein the congestion report includes a recommended bit rate received from a network node for the IP flow.

Clause 7. The apparatus of any of clauses 1-6, wherein the congestion report includes an uplink buffer state or queueing delay of the IP packets of the IP flow transmitted from the modem.

Clause 8. The apparatus of clause 7, wherein the uplink buffer state or queueing delay is represented as hypothetical uplink ECN marking information via the API but transmitted uplink packets are not marked with the hypothetical uplink ECN marking.

Clause 9. The apparatus of any of clauses 1-8, wherein the one or more processors are further configured to execute the computer-executable instructions to cause the apparatus to: receive, at the modem or the operating system via the API, an indication of an ECN codepoint to be applied to an IP flow; identify one or more packets corresponding to the IP flow at a packet data convergence protocol (PDCP) layer; and add the ECN codepoint to an IP header of the one or more packets at the PDCP layer prior to transmission via a wireless protocol.

Clause 10. A method of communication, comprising: receiving, at a modem or an operating system of a wireless device, via an application programming interface (API) accessible by an application, a subscription of the application to an explicit congestion notification (ECN) marking report service for an internet protocol (IP) flow; and providing, to the application via the API, a congestion report based on IP packets of the IP flow marked with an ECN field received at a packet data convergence protocol (PDCP) layer of the modem or based on IP packets of the IP flow transmitted from the modem.

Clause 11. The method of clause 10, wherein providing the congestion report comprises periodically sending the congestion report via the API.

Clause 12. The method of clause 10, wherein providing the congestion report comprises sending the congestion report via the API in response to a number of received packets.

Clause 13. The method of clause 10, wherein providing the congestion report comprises sending the congestion report via the API in response to a request from the application.

Clause 14. The method of any of clauses 10-13, wherein the congestion report includes ECN marking information.

Clause 15. The method of any of clauses 10-14, wherein the congestion report includes a recommended bit rate.

Clause 16. The method of any of clauses 10-15, wherein the congestion report includes an uplink buffer state or queueing delay.

Clause 17. The method of clause 16, wherein the uplink buffer state or queueing delay is represented as hypothetical uplink ECN marking information via the API but transmitted uplink packets are not marked with the hypothetical uplink ECN marking.

Clause 18. The method of any of clauses 10-17, further comprising: receiving, at the modem or the operating system via the API, an indication of an ECN codepoint to be applied to an IP flow; identifying one or more packets corresponding to the IP flow at a PDCP layer; and adding the ECN codepoint to an IP header of the one or more packets at the PDCP layer prior to transmission via a wireless protocol.

Clause 19. A method of communication, comprising: receiving, at a modem or an operating system of a wireless device, via an application programming interface (API) accessible by an application, an indication of an explicit congestion notification (ECN) codepoint to be applied to an IP flow; identifying one or more packets corresponding to the IP flow at a packet data convergence protocol (PDCP) layer; and adding the ECN codepoint to an IP header of the one or more packets at the PDCP layer prior to transmission via a wireless protocol.

Clause 20. The method of clause 19, wherein adding the ECN codepoint to the IP header of the one or more packets comprises apply ECN markings probabilistically based on a rate indicated by the API.

Clause 21. An apparatus comprising: means for receiving, at a modem or an operating system of a wireless device, via an application programming interface (API) accessible by an application, a subscription of the application to an explicit congestion notification (ECN) marking report service for an internet protocol (IP) flow; and means for providing, to the application via the API, a congestion report based on IP packets of the IP flow marked with an ECN field received at a packet data convergence protocol (PDCP) layer of the modem or based on IP packets of the IP flow transmitted from the modem.

Clause 22. A non-transitory computer-readable medium storing computer-executable instructions that when executed by a processor of a wireless device cause the processor to: receive, at a modem or an operating system of the wireless device, via an application programming interface (API) accessible by an application, a subscription of the application to an explicit congestion notification (ECN) marking report service for an internet protocol (IP) flow; and provide, to the application via the API, a congestion report based on IP packets of the IP flow marked with an ECN field received at the modem or based on IP packets of the IP flow transmitted from the modem.

Clause 23. An apparatus comprising: means for receiving, at a modem or an operating system of a wireless device, via an application programming interface (API) accessible by an application, an indication of an explicit congestion notification (ECN) codepoint to be applied to an IP flow; means for identifying one or more packets corresponding to the IP flow at a packet data convergence protocol (PDCP) layer; and means for adding the ECN codepoint to an IP header of the one or more packets at the PDCP layer prior to transmission via a wireless protocol.

Clause 24. A non-transitory computer-readable medium storing computer-executable instructions that when executed by a processor of an extended reality device cause the processor to: receive, at a modem or an operating system of a wireless device, via an application programming interface (API) accessible by an application, an indication of an explicit congestion notification (ECN) codepoint to be applied to an IP flow; identify one or more packets corresponding to the IP flow at a packet data convergence protocol (PDCP) layer; and add the ECN codepoint to an IP header of the one or more packets at the PDCP layer prior to transmission via a wireless protocol.

As used herein, a phrase referring to “at least one of” a list of items refers to any combination of those items, including single members. As an example, “at least one of: a, b, or c” is intended to cover: a, b, c, a-b, a-c, b-c, and a-b-c. Similarly, as used herein, a phrase referring to “one or more of” a list of items refers to any combination of those items, including single members. As an example, “one or more of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus for wireless communication, comprising:
one or more memories storing computer-executable instructions; and
one or more processors configured to execute the computer-executable instructions to cause the apparatus to:
receive, at a modem or an operating system of the apparatus, via an application programming interface (API) accessible by an application, a subscription of the application to an explicit congestion notification (ECN) marking report service for an internet protocol (IP) flow; and
provide, to the application via the API, a congestion report based on IP packets of the IP flow marked with an ECN field received at the modem or based on IP packets of the IP flow transmitted from the modem.

2. The apparatus of claim 1, wherein to provide the congestion report, the one or more processors are configured to execute the computer-executable instructions to cause the apparatus to periodically send the congestion report via the API.

3. The apparatus of claim 1, wherein to provide the congestion report, the one or more processors are configured to execute the computer-executable instructions to cause the apparatus to send the congestion report via the API in response to a number of received packets.

4. The apparatus of claim 1, wherein to provide the congestion report, the one or more processors are configured to execute the computer-executable instructions to cause the apparatus to send the congestion report via the API in response to a request from the application.

5. The apparatus of claim 1, wherein the report includes ECN marking information.

6. The apparatus of claim 1, wherein the congestion report includes a recommended bit rate received from a network node for the IP flow.

7. The apparatus of claim 1, wherein the congestion report includes an uplink buffer state or queueing delay of the IP packets of the IP flow transmitted from the modem.

8. The apparatus of claim 7, wherein the uplink buffer state or queueing delay is represented as hypothetical uplink ECN marking information via the API but transmitted uplink packets are not marked with the hypothetical uplink ECN marking.

9. The apparatus of claim 1, wherein the one or more processors are further configured to execute the computer-executable instructions to cause the apparatus to:
receive, at the modem or the operating system via the API, an indication of an ECN codepoint to be applied to an IP flow;
identify one or more packets corresponding to the IP flow at a packet data convergence protocol (PDCP) layer; and
add the ECN codepoint to an IP header of the one or more packets at the PDCP layer prior to transmission via a wireless protocol.

10. A method of communication, comprising:
receiving, at a modem or an operating system of a wireless device, via an application programming interface (API) accessible by an application, a subscription of the application to an explicit congestion notification (ECN) marking report service for an internet protocol (IP) flow; and
providing, to the application via the API, a congestion report based on IP packets of the IP flow marked with an ECN field received at a packet data convergence protocol (PDCP) layer of the modem or based on IP packets of the IP flow transmitted from the modem.

11. The method of claim 10, wherein providing the congestion report comprises periodically sending the congestion report via the API.

12. The method of claim 10, wherein providing the congestion report comprises sending the congestion report via the API in response to a number of received packets.

13. The method of claim 10, wherein providing the congestion report comprises sending the congestion report via the API in response to a request from the application.

14. The method of claim 10, wherein the congestion report includes ECN marking information.

15. The method of claim 10, wherein the congestion report includes a recommended bit rate.

16. The method of claim 10, wherein the congestion report includes an uplink buffer state or queueing delay.

17. The method of claim 16, wherein the uplink buffer state or queueing delay is represented as hypothetical uplink ECN marking information via the API but transmitted uplink packets are not marked with the hypothetical uplink ECN marking.

18. The method of claim 10, further comprising:
receiving, at the modem or the operating system via the API, an indication of an ECN codepoint to be applied to an IP flow;
identifying one or more packets corresponding to the IP flow at a PDCP layer; and
adding the ECN codepoint to an IP header of the one or more packets at the PDCP layer prior to transmission via a wireless protocol.

19. A method of communication, comprising:
receiving, at a modem or an operating system of a wireless device, via an application programming interface (API) accessible by an application, an indication of an explicit congestion notification (ECN) codepoint to be applied to an IP flow;
identifying one or more packets corresponding to the IP flow at a packet data convergence protocol (PDCP) layer; and
adding the ECN codepoint to an IP header of the one or more packets at the PDCP layer prior to transmission via a wireless protocol.

20. The method of claim 19, wherein adding the ECN codepoint to the IP header of the one or more packets comprises apply ECN markings probabilistically based on a rate indicated by the API.
